(19) United States
(12) Patent Application Publication
(10) Pub. No.: US 2006/0018647 A1
(43) Pub. Date: Jan. 26, 2006

(54) Image pickup apparatus having camera shake correction function, and camera shake correction method

(75) Inventor: Masakuni Iwanaga, Akishima-shi (JP)

Correspondence Address: FRISHAUF, HOLTZ, GOODMAN & CHICK, PC, 220 5TH AVE FL 16, NEW YORK, NY, 10001-7708, US

(73) Assignee: Casio Computer Co., Ltd., Tokyo (JP)

(21) Appl. No.: 11/184,228

(22) Filed: Jul. 19, 2005

(30) Foreign Application Priority Data
Jul. 21, 2004 (JP) 2004-212363

(51) Int. Cl. G03B 17/00

(52) U.S. Cl. 396/55

(57) ABSTRACT

A camera shake correction device comprises a pair of electro-optical effect members refracting an incident light in a first direction and a second direction which are mutually orthogonal, driving means for applying electric fields to the pair of electro-optical effect members, means for detecting amounts of camera shake in the first direction and the second direction, and means for controlling refractive indexes of the pair of electro-optical effect members by controlling the electric fields to be applied to the pair of electro-optical effect members by the driving means depending on the amounts of camera shake in the first direction and the second direction detected by the detecting means.

### CROSS-REFERENCE TO RELATED APPLICATIONS

This application is based upon and claims the benefit of priority from prior Japanese Patent Application No. 2004-212363, filed Jul. 21, 2004, the entire contents of which are incorporated herein by reference.

### BACKGROUND OF THE INVENTION

1. Field of the Invention

The present invention relates to an image pickup apparatus having a camera shake correction function, and a camera shake correction method.

2. Description of the Related Art

Hitherto, as a method of correcting camera shake when taking an image by an image pickup apparatus such as, for example, a digital camera, information of camera shake direction or shake extent is acquired by an acceleration sensor or the like provided in the image pickup apparatus main body, and an image pickup device such as a CCD or an optical system is driven in X, Y directions so as to cancel the camera shake on the basis of the information. Herein, a piezoelectric element is used in an actuator of a drive mechanism for driving the image pickup device or optical system (for example, Jpn. Pat. Appln. KOKAI Publication No. 10-39350).

However, in such a configuration for driving the image pickup device or optical system in the X-axis or Y-axis direction, if a piezoelectric element is used in the actuator of the drive mechanism, the image pickup device or optical system need to be mechanically moved in the X, Y directions when correcting the camera shake. As a result, the structure in the apparatus is complicated, and if the camera is dropped or impacted, the reliability against troubles or the like is lowered.

### BRIEF SUMMARY OF THE INVENTION

The present invention is directed to method and apparatus that substantially obviates one or more of the problems due to limitations and disadvantages of the related art.

According to an embodiment of the present invention, a camera shake correction device comprises:

a pair of electro-optical effect members disposed along an optical path of an optical system, the pair of electro-optical effect members refracting an incident light in a first direction and a second direction which are mutually orthogonal;

driving means for applying electric fields to the pair of electro-optical effect members;

camera shake detecting means for detecting amounts of camera shake in the first direction and the second direction; and

refractive index control means for controlling refractive indexes of the pair of electro-optical effect members by controlling the electric fields to be applied to the pair of electro-optical effect members by the driving means depending on the amounts of camera shake in the first direction and the second direction detected by the camera shake detecting means.

According to another embodiment of the present invention, a camera shake correction method for an optical device comprising a pair of electro-optical effect members disposed along an optical path of an optical system, the pair of electro-optical effect members refracting an incident light in a first direction and a second direction which are mutually orthogonal, the method comprises the steps of:

detecting amounts of camera shake in the first direction and the second direction while applying electric fields to the pair of electro-optical effect members; and

controlling refractive indexes of the pair of electro-optical effect members by controlling the electric fields to be applied to the pair of electro-optical effect members depending on the detected amounts of camera shake in the first direction and the second direction.

According to another embodiment of the present invention, an image pickup apparatus having an image pickup device for taking an object, the apparatus comprises:

a pair of electro-optical effect members disposed along an optical path of an optical system, the pair of electro-optical effect members refracting an incident light in a first direction and a second direction which are mutually orthogonal;

driving means for applying electric fields to the pair of electro-optical effect members;

camera shake detecting means for detecting amounts of camera shake in the first direction and the second direction; and

refractive index control means for controlling refractive indexes of the pair of electro-optical effect members by controlling the electric fields to be applied to the pair of electro-optical effect members by the driving means depending on the amounts of camera shake in the first direction and the second direction detected by the camera shake detecting means.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a perspective exploded view schematically showing essential parts of an optical system of a digital camera according to an embodiment of the invention;

FIG. 2A is a schematic diagram of one example for feeding current to front and rear prisms;

FIG. 2B is a schematic diagram of another example for feeding current to front and rear prisms;

FIG. 3A shows a refraction of an optical axis of light from an object, with the refractive index of the front and rear prisms at a minimum value in an adjustable range;

FIG. 3B shows a refraction of an optical axis of light from an object, with the refractive index of the front and rear prisms at a maximum value in an adjustable range;

FIG. 4 is a partially magnified view showing an optical structure of front and rear prisms;

FIG. 5 is a diagram showing the prism peak height and prism pitch in front and rear prisms;

FIG. 6 is a block diagram of an electrical structure of the digital camera;

FIG. 7 is a flowchart showing procedures of a camera shake correction process in the digital camera; and

FIG. 8 is a diagram corresponding to FIG. 4, showing another embodiment of front and rear prisms.

### DETAILED DESCRIPTION OF THE INVENTION

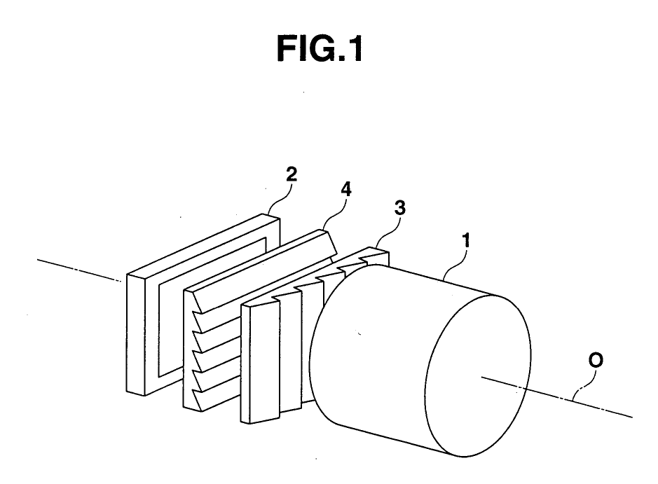

An embodiment of the invention will be described with reference to the accompanying drawings. The embodiment relates to a digital camera which includes an image pickup apparatus, having an optical system shown in FIG. 1 and a camera shake correction device.

FIG. 1 is a perspective exploded view showing main parts of an optical system of a digital camera. Between an imaging lens 1 including a zoom lens composed of a plurality of lenses and a CCD 2 as an image pickup device disposed on its optical axis O, a pair of prisms in plate form, that is, a front prism 3 and a rear prism 4 are disposed mutually in front-rear relation. The both prisms 3, 4 are single-sided linear prisms having prism peaks arrayed on the light incident plane and refracting the incident light in a predetermined direction. The refracting direction of each incident light is mutually orthogonal direction, that is, the refracting direction of the front prism 3 is X-direction (first direction) and that of the rear prism 4 is Y-direction (second direction).

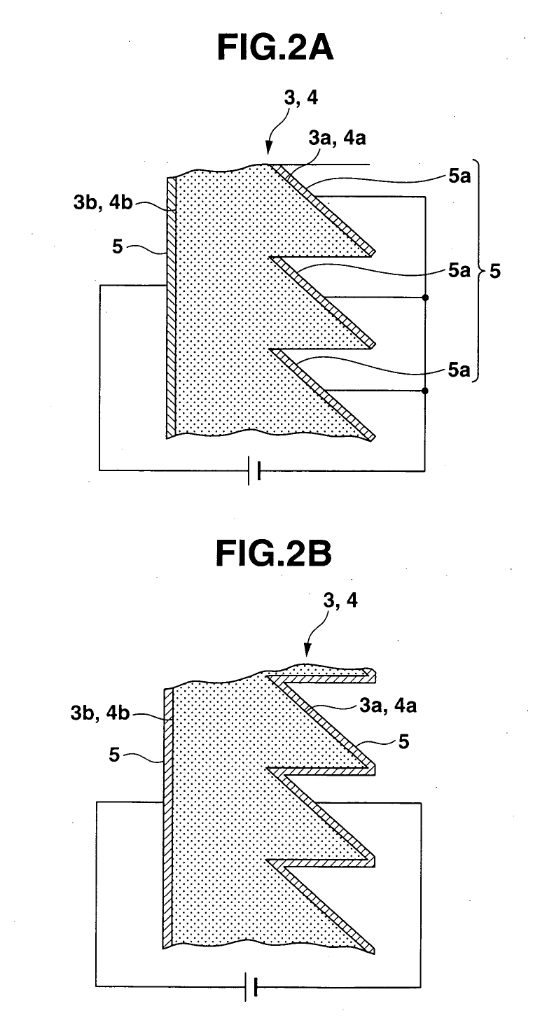

The both prisms 3, 4 are formed of predetermined electro-optical effect materials (for example, various transparent optical crystals used as an optical modulator for communications) which realized a secondary electro-optical effect (Kerr effect) in which the refractive index changes in proportion to square of electric field when an electric field is applied. In light incident planes 3a, 4a and light emitting planes 3b, 4b of the both prisms 3, 4, as shown in FIG. 2A, a transparent electrode 5 is provided for applying a control voltage for controlling or changing the refractive index to change the refracting direction. The layout of the transparent electrode 5 is arbitrary, in the present embodiment as shown in FIG. 2A, the transparent electrode 5 at the side of the incident planes 3a, 4a is divided into plural division electrodes 5a, 5a, 5a, . . . covering only each inclined plane composing the refraction plane of incident light on the incident planes 3a, 4a. However, as shown in FIG. 2B, the transparent electrode 5 at the side of incident planes 3a, 4a may be formed as a single element for covering the entire surface same as emitting planes 3b, 4b.

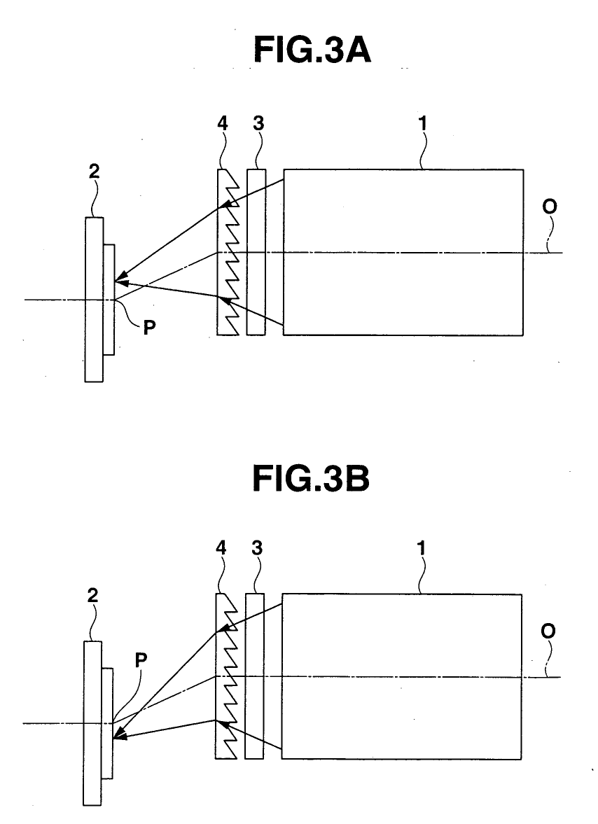

Since the refractive index of the prisms 3, 4 is proportional to the square of control voltage (electric field) as mentioned above, the refractive index is varied by adjusting the control voltage, so that the optical axis of an object image converged on the imaging plane (receiving plane) of the CCD 2 by the imaging lens 1 can be adjusted in the X, Y directions (vertical and lateral directions). FIGS. 3A and 3B show the moving (refracting) state of the optical axis O in the Y direction when the refractive index of the prism 4 is a minimum value of an adjustable range (FIG. 3A) and a maximum value (FIG. 3B). This is a schematic diagram of optical system as seen from a side, in which the CCD 2 is disposed at a position where the center P of the effective pixel region on the imaging plane may coincide with the optical axis O refracting when the refractive index of the prism 4 is set at the intermediate value of the adjustable range. Though not shown, the optical axis O is moved (refracted) in the X direction by controlling or changing the refractive index of the prism 3.

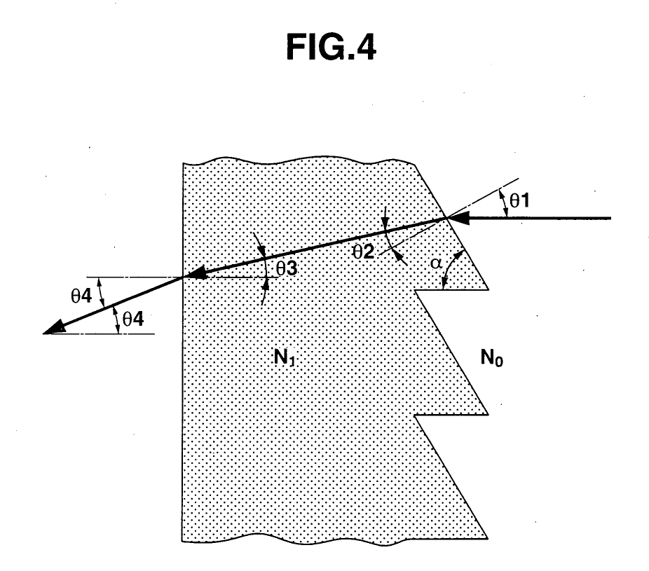

FIG. 4 is a diagram showing the relation among a refractive index N₁ in the both prisms 3, 4, and an incident angle θ1 and a refractive angle θ4 of beam L. Herein, in the case of
θ1=90°−α
then

N₀ sin θ1=N₁ sin θ2
θ3=θ1−θ2

N₀ sin θ4=N₁ sin θ3

Hence, for example, in the case of N₀=1.0, N₁=1.4 to 1.6, and α=75°,

if N₁=1.4, then

θ1=15°

θ2=10.65°

θ3=4.35°

θ4=6.09°

Or if N₁=1.6, then

θ1=15°

θ2=9.31°

θ3=5.69°

θ4=9.13°

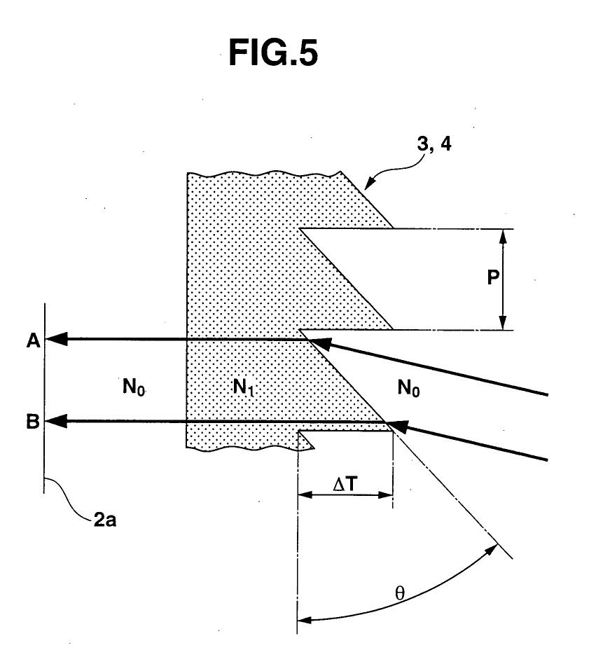

In the both prisms 3, 4, the height ΔT of plural prism peaks arrayed and formed on the incident planes 3a, 4a, and the peak interval of prism peaks (hereinafter referred to as prism pitch) P (see FIG. 5) are set as follows.

That is, the height ΔT and prism pitch P are set according to the minimum value of the depth of field of an object which varies depending on the focal length of imaging lens 1 (the iris is fixed in the embodiment) such that the relation between a focus difference of point A and point B on the imaging plane 2a of the CCD 2 shown in FIG. 5 and the depth of field on the imaging plane 2a may be as predetermined below:

(focus difference)≦(depth of field).

Herein,
ΔT−(ΔT×N₀/N₁))≦(depth of field),
and the relation between the height ΔT and the prism pitch P is
tan θ=ΔT/P
∴ΔT=P× tan θ
The prism pitch P is set to meet the following condition:
(P× tan θ×N₀/N₁)≦(depth of field)

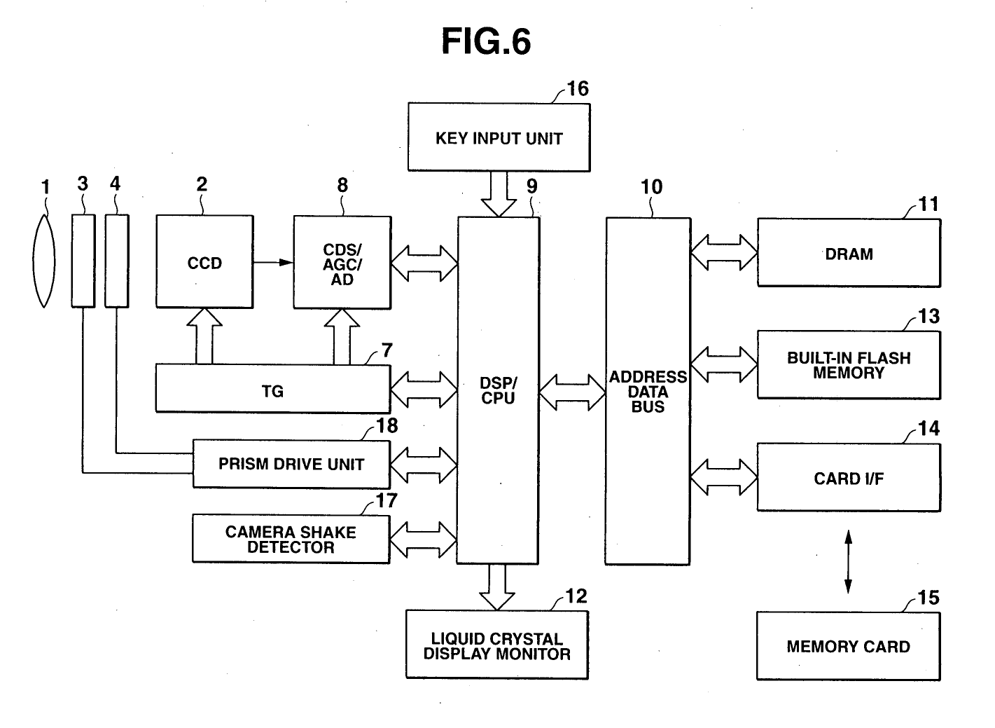

FIG. 6 is a block diagram of an electrical structure of a digital camera having the above optical system. In the digital camera, the subject image is focused on the imaging plane of the CCD 2 through the imaging lens 1, the front prism 3, and the rear prism 4. The CCD 2 is driven by a timing generator (TG) 7, and an analog imaging signal depending on the accumulated charge level of each pixel is output to an analog processing unit 8.

The analog processing unit 8 is composed of a correlated double sampling (CDS) circuit for removing noise included in the imaging signal input from the CCD 2, an automatic gain control (AGC) amplifier for multiplying the imaging signal after noise removal by a predetermined gain, and an A/D converter for converting the imaging signal after gain control to a digital signal of 10-bit notation or the like, and the digitized imaging signal is input to a DSP/CPU 9. The imaging signal input to the DSP/CPU 9 is sequentially sent to a DRAM 11 by way of an address data bus 10, and is stored as image data.

The DSP/CPU 9 controls the parts of the digital camera, and also has various digital signal processing functions including compression and expansion of still image data. Specifically, the DSP/CPU 9 reads out pixel signals stored in the DRAM 11 in a unit of a predetermined image processing block, generates digital image data of R, G, B, converts to image data of a luminance (Y) signal and a color difference (Cb, Cr) signal, and generates a video signal on the basis of the converted image data and sends to a liquid crystal display monitor 12. The liquid crystal display monitor 12 includes a liquid display device capable of color display and its driving circuit, and displays an image on the basis of the video signal, that is, a through-image or the like. As assistance to operation, it also displays processing menu when selecting the function, graphic patterns icons and the like for setting.

The DSP/CPU 9 compresses and encodes Y, Cb, Cr image data in a unit of an image processing block in a predetermined manner when recording image, and expands and decodes when reproducing recorded image. Image data compressed and encoded when taking image is recorded as still image data in a built-in flash memory 13, or various detachable memory cards 15 by way of a card interface 14.

A key input unit 16 includes various keys (not shown) such as a power key, a record/play mode select switch, a shutter release key, a zoom key, and a menu key, and an operation signal according to user's key operation is sent to the DSP/CPU 9. For example, when the shutter release key is pressed in a record mode at the time of taking image, a corresponding trigger signal is sent to the DSP/CPU 9.

A camera shake detector 17 includes an acceleration sensor for detecting accelerations in the X, Y directions (vertical and lateral directions) of the digital camera, and an A/D converter for converting the sensor outputs into digital signals, and the accelerations in the X, Y directions (camera shake signals) after converting into the digital signals are sent to the DSP/CPU 9. A prism drive unit 18 corresponds to driving means of the invention, and on the basis of the control signal sent from the DSP/CPU 10, a control voltage (for example, a voltage for applying an electric field in a range of 0 to 100 V/mm) is applied to the front prism 3 and rear prism 4, and thereby controlling or changing the refractive indexes of the both prisms 3, 4.

The built-in flash memory 13 has a program region separately from an image storage region for storing image data after compression. This program region stores programs for executing the controls by the DSP/CPU 9 as mentioned above, and necessary data. In this embodiment, the DSP/CPU 9 operates according to the program, and functions as camera shake detecting means and refractive index control means of the invention.

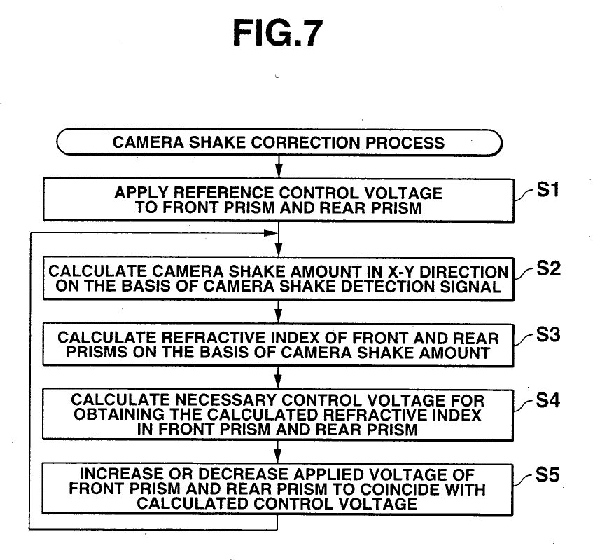

The operation of the invention in the digital camera having such a configuration will be explained below. FIG. 7 is a flowchart showing a camera shake correction process executed by the DSP/CPU 9 when the record mode is set in a power ON state.

When the record mode is set, the DSP/CPU 9 first applies a reference control voltage for setting each refractive index to an intermediate value in the adjustable range, to the front prism 3 and rear prism 4, by means of a prism drive unit 18 (step S1). Next, on the basis of the camera shake detection signals sent from the camera shake detector 17, amounts of camera shake in the X, Y directions of the apparatus main body are calculated (step S2). The refractive index of the front prism 3 corresponding to the amount of camera shake in the X-direction, and the refractive index of the rear prism 4 corresponding to the amount of camera shake in the Y-direction are calculated, that is, each refractive index is calculated to move the position of the optical axis O of light from the object and entering the imaging plane of the CCD 2 so as to cancel the camera shake caused in the apparatus main body (step S3). Further, control voltages necessary for obtaining the calculated refractive indexes are calculated (step S4). Toward the calculated control voltages, the applied voltages (the reference control voltage in initial phase of operation) applied from the prism drive unit 18 to the front prism 3 and rear prism 4 are increased or decreased (step S5). It hence prevents blurring of the optical image of the subject occurring on the imaging plane of the CCD 2. Hereinafter, the same operation of steps S2 to S5 is repeated. Therefore, an image free from camera shake is obtained in the record mode, that is, an image recorded corresponding to user's shutter release operation, and a through-image displayed in waiting time when taking image are obtained.

As described herein, in this embodiment, by controlling the refractive index of the front prism 3 and rear prism 4, blurring of the optical image of the subject occurring on the imaging plane of the CCD 2 can be prevented without being accompanied by mechanical operation, and the structure in the main body of the digital camera can be simplified in spite of having the camera shake correction function. Owing to the same reason, risk of occurrence of trouble such as malfunction is extremely low, and a high reliability is assured.

In this embodiment, moreover, the front prism 3 and rear prism 4 are single-sided linear prisms in which the prism peak has only one inclined plane. Therefore, as compared with general wedge-shaped prisms in which the prism peak has two inclined planes, the optical path length of incident light reaching to the CCD 2 in the optical system (the distance between the imaging lens 1 and the CCD 2 in FIG. 1) can be shortened. It is hence very beneficial for downsizing of the digital camera. Meanwhile, even if the front prism 3 and rear prism 4 are formed in a shape of general wedge-shaped prisms, the same simplification of the structure in the main body and high reliability as mentioned above can be assured.

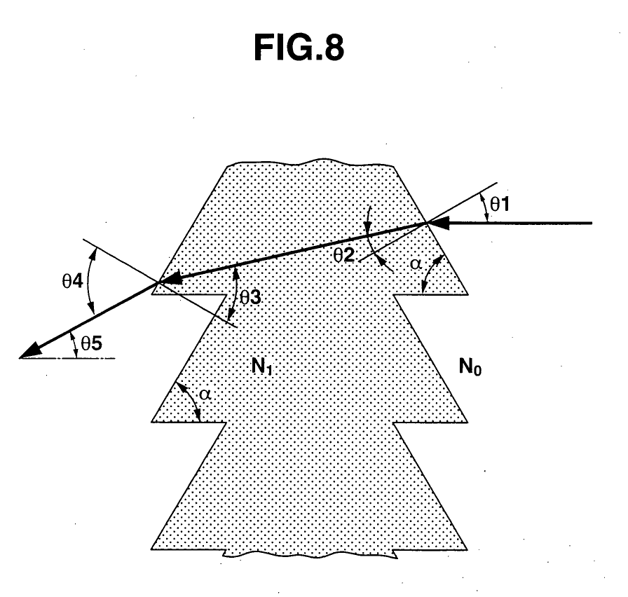

Incidentally, the front prism 3 and rear prism 4 may be double-sided linear prisms having plural prism peaks arrayed on the light incident plane and emitting plane. FIG. 8 corresponds to FIG. 4, and the relation among the refractive index N₁ of the double-sided linear prism, and the incident angle θ1 and refractive angle θ5 of beam L is as follows. That is, if
θ1=90°−α
then,

N₀ sin θ1=N₁ sin θ2
θ3=θ2−θ2+(90°−α)

N₀ sin θ4=N₁ sin θ3
θ5=θ4−(90°−α)
Hence, same as explained about single-sided linear prism, for example, in the case of N₀=1.0, N₁=1.4 to 1.6, and α=75°, if

N₁=1.4,

then

θ1=15°

θ2=10.65°

θ3=19.35°

θ4=27.64°

θ5=12.64°

or if

N₁=1.6,

then

θ1=15°

θ2=9.31°

θ3=20.69°

θ4=34.42°

θ5=19.42°

That is, when the controllable range of the refractive index by the electro-optical effect is the same, a greater camera shake correction amount (moving distance of the optical axis O of the subject light entering the imaging plane of the CCD 2) can be obtained as compared with the single-sided linear prisms. Accordingly, when the front prism 3 and rear prism 4 are formed of double-sided linear prisms, the optical path length of incident light up to the CCD 2 in the optical system can be further shortened, and the digital camera can be further reduced in size.

In the camera shake correction device, image pickup apparatus, and camera shake correction method of the present embodiment, blurring of the optical image obtained from the optical system can be prevented without being accompanied by mechanical motion. Accordingly, a high reliability against trouble is assured, and the structure of the optical device can be simplified.

In this embodiment, both of the front prism 3 and rear prism 4 are single-sided linear prisms, but one of the prisms 3, 4 may be formed of single-sided linear prism or double-sided linear prism. In such a case, as compared with the case of both prisms 3, 4 formed of general wedge-shaped prisms, the optical path length of incident light up to the CCD 2 in the optical system can be further shortened, and the same effects as in the embodiment can be obtained. When using the double-sided linear prism as well, the transparent electrode provided on the incident plane and emitting plane may be composed of plural division electrodes for covering only the inclined plane forming the refraction plane of the incident light, or may be composed of a single element covering the entire surface.

In the embodiment, while the record mode is being set, the DSP/CPU 9 is designed to execute the camera shake correction process repeatedly, but may execute also as follows. For example, in the case where the digital camera is provided with an imaging prenotice operation function called half-shutter, the camera shake correction process is started when the shutter release key is pressed in half in record mode, and the camera shake correction process may be stopped when this state is canceled after the shutter release key is pressed in half.

Aside from the camera shake correction process, moreover, in the case of imaging operation by the shutter release key, or imaging corresponding to full stroke pushing operation after half stroke pushing, the refractive index of the front prism 3 and rear prism 4 is changed such that the optical axis O of the object light entering the imaging plane of the CCD 2 may be moved by slightly less than one pixel in the longitudinal and lateral directions with the exposure time, and thereby the both prisms 3, 4 can function as low pass filters.

In the explanation above, the invention is mainly applied in a digital camera for taking and recording a still image, but the invention may be applied also to other image pickup apparatuses such as a digital video camera and a portable telephone with a camera function.

The camera shake correction device of the invention can be applied in other optical devices having an optical system, such as binoculars, telescope or microscope as well as in the image pickup apparatus mentioned above. Also in such cases, blurring of the optical image obtained from the optical system can be prevented without being accompanied by mechanical motion, and even when these optical devices are provided with the camera shake preventive function, a high reliability against trouble is assured, and the structure of the optical device can be simplified.

What is claimed is:

1. A camera shake correction device comprising:
a pair of electro-optical effect members disposed along an optical path of an optical system, the pair of electro-optical effect members refracting an incident light in a first direction and a second direction which are mutually orthogonal;
driving means for applying electric fields to the pair of electro-optical effect members;
camera shake detecting means for detecting amounts of camera shake in the first direction and the second direction; and
refractive index control means for controlling refractive indexes of the pair of electro-optical effect members by controlling the electric fields to be applied to the pair of electro-optical effect members by the driving means depending on the amounts of camera shake in the first direction and the second direction detected by the camera shake detecting means.

2. The camera shake correction device according to claim 1, wherein at least one of the pair of electro-optical effect members comprises a single-sided linear prism having plural prism peaks arrayed on one of a light incident plane and a light emitting plane.

3. The camera shake correction device according to claim 1, wherein at least one of the pair of electro-optical effect members comprises a double-sided linear prism having plural prism peaks arrayed on a light incident plane and a light emitting plane.

4. The camera shake correction device according to claim 2, wherein transparent electrodes are provided on the light incident plane and the light emitting plane of the pair of electro-optical effect members, and the transparent electrode provided on one of the light incident plane and the light emitting plane which has plural peaks arrayed thereon comprises plural division electrodes which cover only inclined planes of the prism peaks forming a refraction plane of the incident light, and
the driving means applies the electric fields to the pair of electro-optical effect members by applying a control voltage between the transparent electrodes of the light incident plane and the light emitting plane.

5. The camera shake correction device according to claim 2, wherein transparent electrodes which cover an entire surface are provided on the light incident plane and the light emitting plane of the pair of electro-optical effect members, and
the driving means applies the electric fields to the pair of electro-optical effect members by applying a control voltage between the transparent electrodes of the light incident plane and the light emitting plane.

6. A camera shake correction method for an optical device comprising a pair of electro-optical effect members disposed along an optical path of an optical system, the pair of electro-optical effect members refracting an incident light in a first direction and a second direction which are mutually orthogonal, the method comprising the steps of:
detecting amounts of camera shake in the first direction and the second direction while applying electric fields to the pair of electro-optical effect members; and
controlling refractive indexes of the pair of electro-optical effect members by controlling the electric fields to be applied to the pair of electro-optical effect members depending on the detected amounts of camera shake in the first direction and the second direction.

7. An image pickup apparatus having an image pickup device for taking an object, the apparatus comprising:
a pair of electro-optical effect members disposed along an optical path of an optical system, the pair of electro-optical effect members refracting an incident light in a first direction and a second direction which are mutually orthogonal;
driving means for applying electric fields to the pair of electro-optical effect members;
camera shake detecting means for detecting amounts of camera shake in the first direction and the second direction; and
refractive index control means for controlling refractive indexes of the pair of electro-optical effect members by controlling the electric fields to be applied to the pair of electro-optical effect members by the driving means depending on the amounts of camera shake in the first direction and the second direction detected by the camera shake detecting means.

8. The image pickup apparatus according to claim 7, wherein at least one of the pair of electro-optical effect members comprises a single-sided linear prism having plural prism peaks arrayed on one of a light incident plane and a light emitting plane.

9. The image pickup apparatus according to claim 7, wherein at least one of the pair of electro-optical effect members comprises a double-sided linear prism having plural prism peaks arrayed on a light incident plane and a light emitting plane.

10. The image pickup apparatus according to claim 8, wherein transparent electrodes are provided on the light incident plane and the light emitting plane of the pair of electro-optical effect members, and the transparent electrode provided on one of the light incident plane and the light emitting plane which has plural peaks arrayed thereon comprises plural division electrodes which cover only inclined planes of the prism peaks forming a refraction plane of the incident light, and
the driving means applies the electric fields to the pair of electro-optical effect members by applying a control voltage between the transparent electrodes of the light incident plane and the light emitting plane.

11. The image pickup apparatus according to claim 8, wherein transparent electrodes which cover an entire surface are provided on the light incident plane and the light emitting plane of the pair of electro-optical effect members, and
the driving means applies the electric fields to the pair of electro-optical effect members by applying a control voltage between the transparent electrodes of the light incident plane and the light emitting plane.
